(19) United States
(12) Patent Application Publication
(10) Pub. No.: US 2013/0264472 A1
(43) Pub. Date: Oct. 10, 2013

(54) MEASURING TRANSDUCER FOR OBTAINING POSITION DATA AND METHOD FOR ITS OPERATION

(71) Applicant: SIEMENS AKTIENGESELLSCHAFT, Munchen (DE)

(72) Inventors: Jürgen Schimmer, Nurnberg (DE); Ulrich Wetzel, Erlangen (DE); Jürgen Zettner, Veitsbronn (DE)

(73) Assignee: Siemens Aktiengesellschaft, Munchen (DE)

(21) Appl. No.: 13/856,090

(22) Filed: Apr. 3, 2013

(30) Foreign Application Priority Data
Apr. 4, 2012 (EP) 12163172.5

(51) Int. Cl. G01D 5/32; G01D 5/347

(52) U.S. Cl. CPC G01D 5/32; G01D 5/347
USPC 250/231.1

(57) ABSTRACT

A measuring transducer for obtaining position data, with a transmit/receive unit having a plurality of light sources for scanning a dimensional scale, wherein the transmit/receive unit includes several light sources, in particular at least one light source having a plurality of emitters.

### CROSS-REFERENCES TO RELATED APPLICATIONS

This application claims the priority of European Patent Application, Serial No. EP 12163172.5, filed Apr. 4, 2012, pursuant to 35 U.S.C. 119(a)-(d), the content of which is incorporated herein by reference in its entirety as when fully set forth herein.

### BACKGROUND OF THE INVENTION

The present invention relates to a measuring transducer, which may also be referred to in abbreviated form as a transducer or rotary transducer, for obtaining position data and a method for operating a measuring transducer. Such measuring transducers may be implemented as absolute transducers or incremental transducers and may be based on optical scanning of a dimensional scale.

Furthermore, the invention also relates to a unit having such a measuring transducer, for example a drive or an electric motor, in order to obtain at that point position data relating to a speed or position of the motor/drive or generally of the respective unit.

Measuring transducers, especially measuring transducers for drive technology, are subject to particularly high demands on their operational reliability and fault tolerance.

Semiconductor light sources, for example laser diodes, whose service life and operational robustness is critically affected by maximum and minimum operating temperatures, are required for rotary transducers based on a microstructured, diffractive, absolute optical coding. On the one hand this depends on cyclical loading due to temperature fluctuations during repetitive activation and de-activation of such light sources, and on the other hand on diffusion processes which occur at high temperatures, and in this case lead to undesirable doping, crystal damage and the like. Equally, high demands of the application, for example a rotary transducer integrated in a motor, affect packaging as well as the construction and interconnection technologies.

The suitability of such measuring transducers for industrial use, especially where there are particular requirements to be met regarding their reliability in continuous operation, has hitherto not been optimal.

It would therefore be desirable to obviate prior art shortcomings and to provide an improved measuring transducer and a method for its operation.

### SUMMARY OF THE INVENTION

According to one aspect of the present invention, a measuring transducer for obtaining position data, includes a transmit/receive unit having a plurality of light sources for scanning a dimensional scale. At least one light source may have a plurality of emitters. In this case, semiconductor lasers are considered as light sources or emitters. A unit containing a plurality of such emitters, in which each emitter functions as an independent, potential light source, will hereinafter generally be referred to as a light source.

At present, such semiconductor lasers, in particular Vertical Cavity Surface Emitting Lasers (also referred to as VCSEL emitters), are not designed for an industrial application at high temperatures. In an application of such semiconductor lasers, the individual emitters are usually also individually positioned. VCSEL arrays are known from communications technology and for laser lighting, as well as for increasing total radiated power.

According to another aspect of the invention, a method for operating a measuring transducer, and more particularly a method for obtaining position data by scanning a dimensional scale with a measuring transducer of a transmit/receive unit having a plurality of light sources, with at least one light source having a plurality of emitters, includes activating a subset of emitters of the plurality of emitters simultaneously so as to obtain a specified minimum signal power. Instead of activating a subset of emitters simultaneously, individual emitters or groups of emitters may be activated as a replacement for or in addition to other emitters or groups of other emitters.

According to an advantageous feature of the present invention, the laser diodes in a light source having a plurality of laser diodes, in particular a plurality of integrated VCSEL emitters, may be utilized in different ways to increase the tolerance of the mechanical construction of the measuring transducer and/or the reliability, by means of redundancy. In addition, this advantage is achievable in a relatively economical way. Furthermore, the combination or integration of a plurality of laser emitters brings significant advantages with regard to mechanical tolerance and operational reliability.

When an optimum emitter fails at any one time, another emitter may be used in its place, in particular an emitter having the next best resulting signal quality after the optimum emitter, producing redundancy so that the measuring transducer can still be used even when one emitter fails when several emitters successively fail. Here a best possible emitter is an emitter whose activation produces a best possible image on the basis of the scanning beam emitted by this emitter.

Advantageously, an increase in the service life of the measuring transducer, i.e. an increase in its usability in service, may be achieved by a specific sequence of the application (activation) of the individual integrated laser emitters. Consequently, a resulting total ON-time is distributed among the emitters in use. With a number of usable emitters denoted symbolically by N, the service life of the measuring transducer can be theoretically increased by the factor N.

Furthermore, the integrated emitters may advantageously be used at times to increase the total beam intensity, in particular when they image (scan) the same hologram with only a radial offset and the position of the imaged bit pattern differs by only a few pixels (in this case the only condition is on the one hand an identical bit information consisting of 1 to N pixels with a minimum signal amplitude and a clear bit separation with an adequate distance to the next bit, likewise consisting of N pixels). Consequently, even at high operating temperatures, sufficient power can still be produced to read the dimensional scale, i.e. the absolute track, for example, and a partial corruption of computer-generated holograms (CGH) functioning as the dimensional scale can be compensated.

According to another advantageous feature of the present invention, the transmit/receive unit may include at least one light source having a plurality of emitters arranged in a row. In such a linear type of arrangement of all emitters of a light source, a radial or a tangential alignment of an absolute and/or incremental track can be considered as the dimensional scale. The related possibilities and advantages are described further on.

According to another advantageous feature of the present invention, the transmit/receive unit may include at least one light source having a plurality of emitters arranged in a matrix-type structure. The increased number of emitters contained by the light source in the matrix-type structure presents additional possibilities in respect of the usability period of the measuring transducer because, simply put, in the event of an age-related failure of individual emitters a larger number of alternate usable emitters is available for compensating one or more failed emitters. Furthermore, a two-dimensional structure of such a light source having emitters arranged in a matrix-type structure advantageously also enables compensation of an unsuitable or defective orientation of the light source and/or of the detector with respect to a scanned dimensional scale. This will be described in more detail below.

In a method for operating a measuring transducer with a light source and a plurality of emitters which can be activated simultaneously within the light source irrespective of any linear or matrix-type arrangement, a plurality of emitters may be activated automatically and simultaneously for obtaining a specified or specifiable minimum signal power. A plurality of emitters can here be activated simultaneously and automatically, because a signal power of the images recorded during operation is likewise recorded regularly and automatically detect and is compared with a specified or specifiable threshold value. When the value falls below the threshold value, at least one further emitter is activated automatically, i.e. for example by control electronics contained in the measuring transducer. When necessary, individual emitters may also be operated at reduced power, so that when the signal power is below the threshold value, for example, an already active emitter remains in operation and a further emitter is additionally activated at half power, for example. An automatic selection of an additional emitter or of a plurality of emitters made by the control electronics depends, at least partly, on a position of such additional emitters that can be activated within the light source and/or in relation to the emitter or to every emitter already in operation. Principally, all conceivable geometric patterns may be considered in this case when a group of simultaneously active emitters and their position together is to be considered as a pattern.

According to another advantageous feature of the present invention, in the event of a failure or an imminent failure of an emitter, either this emitter is de-activated and in its place at least one other emitter is activated automatically or this emitter remains activated and additionally another emitter is activated. The emitters contained in the light source are then utilized as a redundant replacement or a redundant addition for failing, failed or no longer adequately radiating emitters.

According to another advantageous feature of the present invention, successive individual emitters or groups of emitters may be activated automatically—i.e. for example by control electronics contained in the measuring transducer—and resulting images registered by a detector of the measuring transducer may be evaluated to identify and then activate a best possible emitter or a group of best possible emitters. In a light source having a plurality of emitters, a most suitable emitter or a group of most suitable emitters for scanning the dimensional scale may be identified and then automatically activated in this way. Such a process can be initiated following installation of the measuring transducer and as a part of setup process. The process itself can run automatically under the control of the control electronics, for example, and the emitter or each emitter identified within the framework of such a process is stored, so that its or their automatic activation can take place at the conclusion of the identification process.

The invention may at least partially be implemented in software. The invention therefore also relates to a computer program with program code instructions executable by a computer and on the other hand is a storage medium having such a computer program, as well as finally also a measuring transducer having control electronics with a processing unit in the form of or a type of a microprocessor or ASIC, and a memory in which such a computer program can be stored or loaded as a means for implementing the method and its embodiments, which computer program can be or is executed by its processing unit during the operation of the measuring transducer. Here the software aspect of the invention relates in particular to the automatic activation and de-activation of individual emitters according to a scheme coded in software, that is for example for compensating a failed emitter or for selecting a best possible emitter or a best possible group of emitters, as well as for temporarily storing results of an evaluation of images due to activation of individual emitters or a group of emitters in conjunction with data for coding the one emitter or each respective original emitter.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a measuring transducer for obtaining position data, with the measuring transducer including a transmit/receive unit with a light source,

FIG. 2 shows a light source having a plurality of laser diodes (emitters), which are arranged in a row,

FIG. 3 shows a light source having a plurality of laser diodes (emitters), which are arranged in a matrix,

FIG. 4 shows an example of an orientation of a light source having a plurality of linearly arranged emitters (FIG. 2) in relation to a dimensional scale mounted on a rotatable disk (radial orientation),

FIG. 5 shows an example of an orientation of a light source having a plurality of linearly-arranged emitters (FIG. 2) in relation to a dimensional scale mounted on a rotatable disk (tangential orientation),

FIG. 6 shows an example of an orientation of a light source having a plurality of emitters arranged in the form of a matrix (FIG. 3) in relation to a dimensional scale mounted on a rotatable disk,

FIG. 7 shows an image resulting from a simultaneous activation of at least two emitters when scanning an absolute track as a dimensional scale,

FIG. 8 shows an image resulting from a simultaneous activation of at least two emitters when scanning an incremental track as a dimensional scale, and

FIG. 9 shows a comparison of resulting signal powers, once when activating just one emitter (solid line) and once when activating at least two emitters (dashed line), as a function of temperature.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

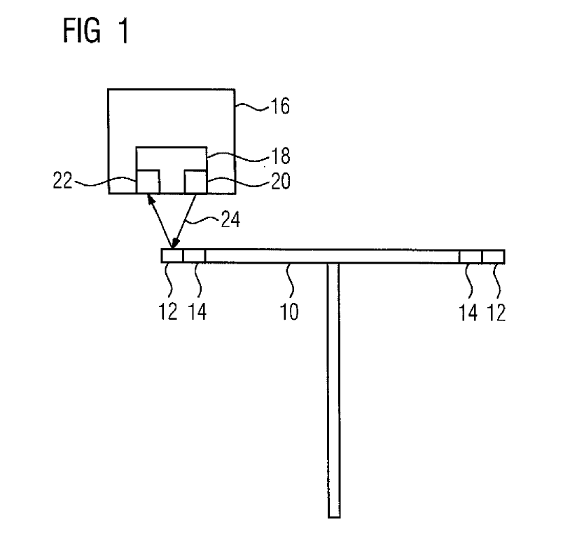

Turning now to the drawing, and in particular to FIG. 1, there is shown a simplified schematic view of a rotatable disk 10 with a dimensional scale. An absolute track 12 positioned concentrically to an outer circumferential line of the disk 10, and a similarly positioned incremental track 14, are each shown only schematically in simplified form as the dimensional scale. The dimensional scale, i.e. the absolute track 12 and/or the incremental track 14, is scanned by a measuring transducer which is described here and in the following in abbreviated form as a measuring transducer 16 for obtaining position data. This is shown as scanning the absolute track 12.

In order to obtain position data, the measuring transducer 16 contains a transmit/receive unit 18 (OPU) with which the respective dimensional scale 12, 14 is scanned. For this, the transmit/receive unit 18 contains at least one light source 20, i.e. a VCSEL chip for example, for generating a scanning beam 22, i.e. in particular for generating a laser beam, as well as at least one detector 22 for detecting an optical code resulting from a reflection or transmission of a scanning beam 24 emitted by the light source 20. The detection of the optical code shown here is for the case of a reflection on the respective dimensional scale, i.e. here the absolute track 12.

The rotatable disk 10 is only one example of how position data can be obtained with a measuring transducer 16, in this case position data with respect to the rotational position of the disk 10. Such a disk 10 can be assigned to a drive (not shown) and thence to a motor shaft, for example, in order to detect a rotational speed or rotational position of the motor shaft. Furthermore, a disk 10 is also only one example of a mounting position for a dimensional scale. In principle, the dimensional scale could, in the case of a drive for example, also be directly attached to the relevant monitored shaft, i.e. the motor shaft, for example.

Correspondingly, the representation in FIG. 1 is primarily chosen with regard to graphical, simply displayable and therefore clear relationships. Also in this case, no particular importance has been placed on an only approximate true-scale representation of absolute and incremental tracks 12, 14 in relation to the measuring transducer 16 and its transmit/receive unit 18, and simultaneous scanning of absolute and incremental tracks 12, 14 and simultaneous detection of an image of a resulting reflection or transmission are also possible. Finally, dimensional scales and their scanning, which have only one absolute track 12 or only one incremental track 14, are also possible and meaningful.

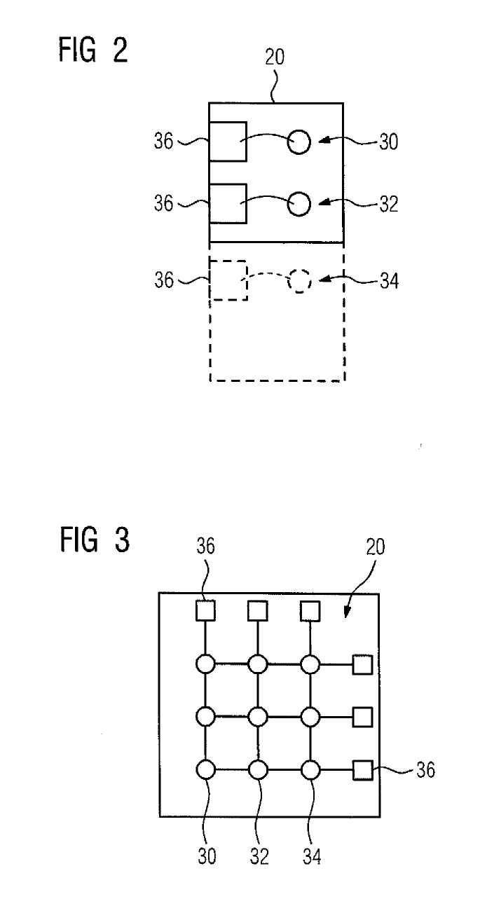

FIG. 2 and FIG. 3 show different embodiments of a light source 20 (see also FIG. 1), i.e. a VCSEL chip, for example, with in each case a plurality of emitters 30, 32, 34 for emitting a scanning beam 24 (FIG. 1), in which each individual emitter functions by itself as a light source, but all together are contained in a unit described as a light source 20. The represented light source 20 includes a first and a second emitter 30, 32 as well as an optional additional emitter 34, with the actual number of emitters 30-34 being basically arbitrary. The representation of the light source 20 also includes bond pads 36 for connecting the emitters 30-34.

Whereas FIG. 2 shows a light source 20 with linearly arranged emitters 30-34, FIG. 3 shows a light source 20 with emitters 30-34 arranged in a matrix. The illustrated 3x3 structure is arbitrary and instead of the total of nine emitters 30-34 resulting from such a structure (only individual ones are indicated), a light source 20 having more or fewer emitters 30-34 and also having an uneven number of lines and columns in the matrix-type structure can also be used.

When using a VCSEL chip, the light source 20 in FIG. 2 can also be described as a VCSEL array. A corresponding light source 20 having a structure as shown in FIG. 3, can correspondingly be termed a VCSEL array.

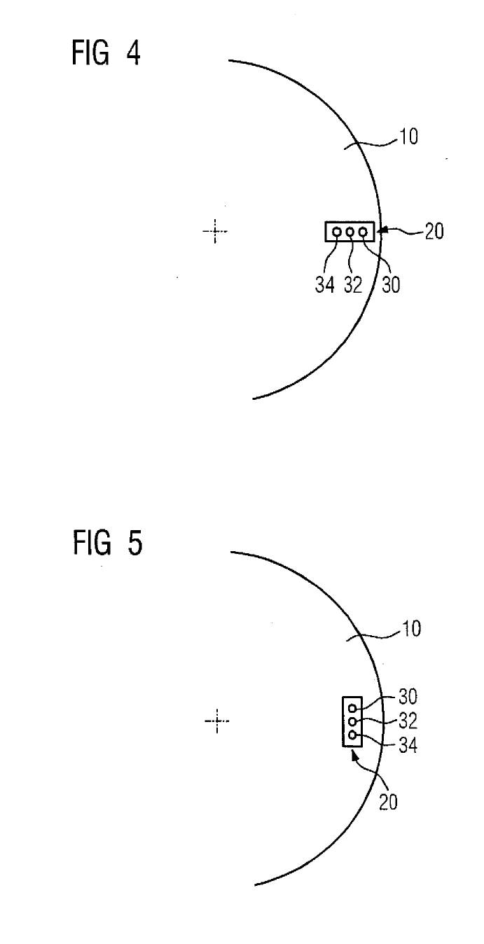

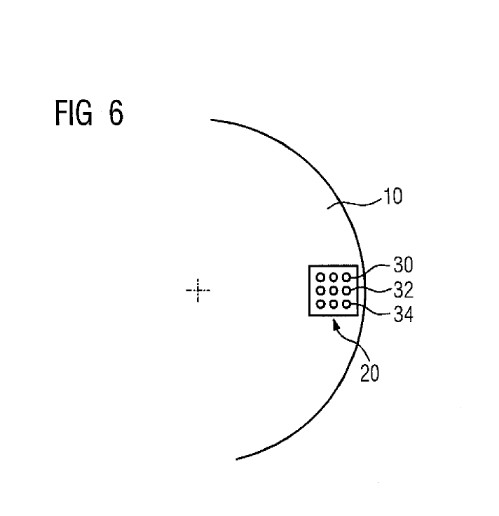

The representation in FIG. 4, FIG. 5 and FIG. 6 shows different types of attachment of a light source 20 with regard to each dimensional scale to be scanned, namely in the example of different orientations of VCSEL chips as shown in FIG. 2 and FIG. 3 in relation to a dimensional scale mounted on a rotatable disk 10 (see also FIG. 1).

In this connection, FIG. 4 shows a radial orientation of emitters 30-34 contained in the light source 20 in relation to the dimensional scale positioned concentrically to an outer circumferential line of the disk 10, that is say for example an absoluter track 12 (FIG. 1). FIG. 5 shows a radial orientation of the emitters 30-34 contained in the light source 20 in relation to a dimensional scale positioned concentrically to an outer circumferential line of the disk 10. Finally, FIG. 6 shows the orientation of a VCSEL array as a light source 20.

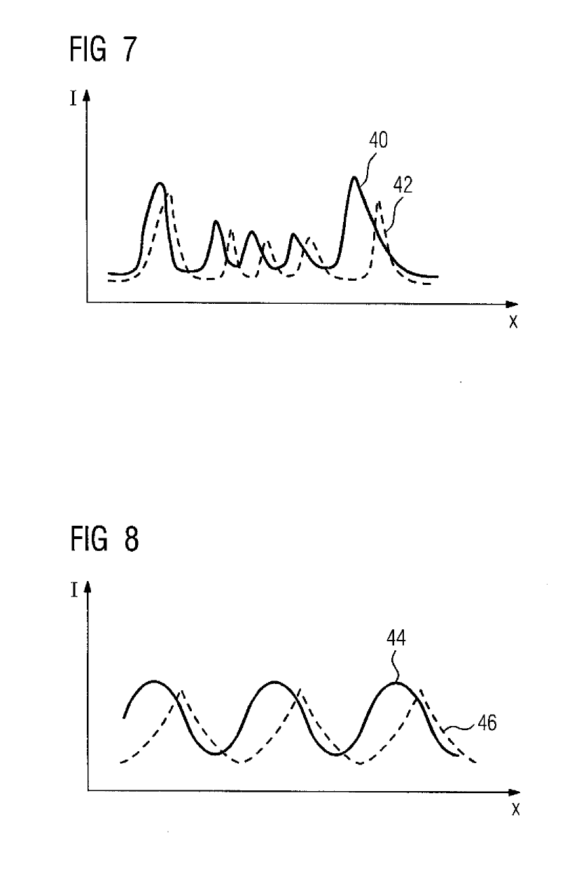

FIG. 7 shows an absolute signal 40 of a first emitter 30 or of a first emitter group 30-34 resulting from the scanning of an absolute track 12, and for comparison, an absolute signal 42 of another emitter 32, 34 or of another emitter group 30-34.

The representation in FIG. 7 also shows that defined emitter arrangements (FIG. 2 to FIG. 6) can be used to map slightly displaced bit patterns (for example Gray codes and the like) on the detector 22 of the measuring transducer 10. For this, in each case the emitters 30-34 differ from adjoining emitters 30-34 in their spatial position by a few tens of pm. This displacement can be satisfactorily detected on a line detector (FIG. 2, FIG. 4, FIG. 5) for reading an absolute track 12. Consequently, in the installation state this information is suitable for determining the best possible imaging emitter in the beam path produced by the mounting. Here the choice of the best possible imaging emitter 30-34 is guided by specified or specifiable criteria in relation to different recorded absolute signals 40, 42. One option for selecting a best possible imaging emitter 30-34 therefore consists in selecting those emitters 30-34 whose absolute signal 40, 42 is distinguished by the highest maximum. Other criteria could be the higher mean value of all signal amplitudes or also parameters which describe a waveform of the resulting absolute signals 40, 42.

Such a selection of a best possible imaging emitter 30-34 can be realized in a particularly satisfactory manner in a tangential orientation of the emitters 30-34 (FIG. 4), because in such a tangential orientation the plurality of emitters 30-34 are oriented parallel (in line) to an aperture or other optical system for producing a severely limited, slit-shaped laser spot. In this case a mechanical adjustment is sometimes actually unnecessary since the sequence of the emitters and their respective signal quality can be determined and stored during commissioning by switching the emitters 30-34 on in a step-by-step manner.

Due to the arrangement in a matrix-like form (FIG. 3, FIG. 6), a maladjustment of a line detector functioning as a detector 22, in the form of a rotation, can in fact be compensated, for example, by activating emitters 30-34 that are diagonally arranged within the matrix. Intermediate emitter positions, i.e. defined angular positions, are adjustable using appropriate intensities of the individual emitters 30-34.

During scanning of an incremental track 14 (FIG. 1), FIG. 8 shows a resulting incremental signal 44 of a first emitter 30 or of a first emitter group 30-34 and an incremental signal 46 of another emitter 32, 34 or of another emitter group 30-34.

The position of the emitter or each of the active emitters 30-34 with respect to the sinusoidal aperture is crucial for a signal quality of an incremental signal 44, 46 originating from an incremental track 14. Optimum filtering exists when a best possible tangential orientation of emitters 30-34 or of emitter group 30-34, aperture and detector 22 is achieved. The close tolerance limits which apply here can be met by activation of individual or a plurality of emitters 30-34 functioning as a quasi adjustment of a resulting laser spot.

The decision as to whether the emitter 30-34 or which group of emitters 30-34 leads to a best possible image is made by comparing the waveform of the resulting incremental signals 44, 46. The representation in FIG. 8 shows an essentially sinusoidal signal as the resulting incremental signal 44 of a first emitter 30 or of a first emitter group 30-34. In contrast, a signal that is distorted in comparison with a sinusoidal signal is shown as the incremental signal 46 of another emitter 32, 34 or of another emitter group 30-34. In an evaluation of the waveform of the resulting incremental signals 44, 46, the signal shown would be selected as the resulting incremental signal 44 of a first emitter 30 or of a first emitter group 30-34 and the signal-initiating first emitter 30 or the signal-initiating first emitter group 30-34 would be selected as the best possible signal. Suitable criteria can be stored for evaluation of a waveform of the resulting incremental signals 44, 46. In this case, examination of the stability of the resulting incremental signals 44, 46 or an initial derivation of the resulting incremental signals 44, 46 can be considered, for example.

In addition, the resulting signal waveform (incremental signal 44, 46) of the next best emitters 30-34 for the incremental track 14, can be stored during commissioning, either for correction according to tables or for signaling the achievable, possibly reduced, incremental resolution in the case of a bad signal waveform.

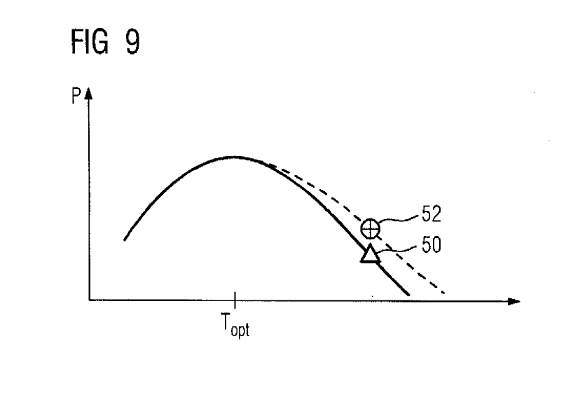

FIG. 9 shows a curve of a signal power 50 on activation of precisely one emitter 30-34 of a light source 20 containing a plurality of emitters 30-34. In comparison to this, a further curve of a signal power 52 as produced during simultaneous activation of two emitters 30-34 of a light source 20 containing a plurality of emitters 30-34, for example, is shown. Here the signal power is plotted on the ordinate and the curves 50, 52 are plotted above a temperature denoted symbolically by T. In this case, a maximum signal power occurs at an optimum temperature denoted by Tₒₚₜ. Furthermore, it can be seen that the signal power reduces beyond the optimum temperature Tₒₚₜ. Due to the simultaneous activation of a plurality of emitters 30-34 of a light source 20, the signal power can also be increased in the area of high temperatures and adequate or at least better signal power obtained.

Although the invention has been illustrated and described in detail by means of the exemplary embodiment, the invention is therefore not restricted by the disclosed example or examples, and the person skilled in the art can derive other variations from these without going beyond the scope of protection of the invention.

The combination or integration of a plurality of laser emitters 30-34 has advantages with regard to the mechanical tolerance as well as operational reliability and assumes detailed knowledge of the optical principle of operation of diffractive optics and of the typical construction of binary coded encoder disks 10 in interaction with the transmit/receive unit (OPU) 18.

As explained above in conjunction with FIG. 9, such a combination of a plurality of emitters 30-34 is considered in dealing with a problem which arises from the fact that laser emitters 30-34 are temperature-sensitive. Laser emitters are normally only intended for operation in a temperature range of up to 105° C. However, this is not adequate for many applications and a temperature range of up to 120° C. would be desirable.

Of course, an increased temperature range has a detrimental effect on the service life of the laser emitters 30-34. However, a reduced service life can be compensated in that in each case a plurality of laser emitters 30-34 is provided and that in the event of an age-related failure of one laser emitter 30-34, another laser emitter 30-34 or a plurality of other laser emitters 30-34 can be activated or is activated in its place.

Moreover, a temperature increase also results in a drift in the wavelength range. The result of the drift in the wavelength range is that the focusing of ₜhe resulting image (FIG. 7, FIG. 8) is possibly less satisfactory. In addition, the intensity of the resulting image (FIG. 7, FIG. 8) in the expected range can also be less satisfactory (lower signal power; FIG. 9). Moreover, these effects are amplified with increasing life span. These undesirable effects, i.e. unsatisfactory focusing, wavelength drift, reducing intensity, etc., can be avoided to a significant extent by not using just one emitter 30-34, but two or more emitters 30-34 or a group of emitters 30-34.

These emitters 30-34 can be connected in a variety of ways, so that, for example, activation of an additional emitter 30-34 only takes place when, during evaluation of a recorded image, deviations from an expected scenario are detected. Additionally or alternately, it is possible to activate another emitter 30-34 after a specific operating period, additionally or alternately, in a time-dependent, i.e. quasi service-life-dependent manner.

Otherwise it is possible in a light source 20 having a matrix-type arrangement of emitters 30-34 to activate these so as to obtain a maximum back-up effect and an optimum laser spot orientation, as well as an optimum image resulting from this. In this case an optimum orientation is a radial orientation (FIG. 4), which naturally can be achieved with a light source 20 having optimum orientation and a plurality of emitters 30-34 (FIG. 2) arranged in a row, but also with a light source 20 having a plurality of emitters 30-34 (FIG. 3) in a matrix-type arrangement, in which individual emitters 30-34 are activated so that the total overlay of the individual laser spots of each emitter 30-34 results in an optimum radially oriented laser spot.

In a tangential orientation of a light source 20 having emitters 30-34 (FIG. 2) arranged in a row, three resulting images are also produced by simultaneous activation of three emitters 30-34, for example. However, these can differ significantly/intensively because one of the emitters 30-34 is unfavourably positioned with respect to the dimensional scale, for example. Differences in intensity can, however, also point to the fact that the respective emitter 30-34 is nearing the end of its service life and the intensity is therefore reduced. Such observations can therefore be evaluated automatically, to the effect that in an image which does not meet specified or specifiable criteria (intensity, signal amplitude, etc.), the corresponding emitter 30-34 is automatically de-activated. A functional test of a light source 20 containing a plurality of emitters 30-34 would be possible in this way.

Individual, prominent aspects of the description submitted here can be briefly summarized as follows:

Specified first and foremost is a measuring transducer 16 for obtaining position data, with the measuring transducer 16 containing a transmit/receive unit 18 for scanning a dimensional scale and with the transmit/receive unit 18 containing a plurality of light sources, in particular at least one light source 20 having a plurality of emitters 30, 32, 34, namely laser diodes, in particular VCSEL emitters, for example.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A measuring transducer for obtaining position data, comprising a transmit/receive unit having a plurality of light sources for scanning a dimensional scale.

2. The measuring transducer of claim 1, wherein at least one light source comprises a plurality of emitters.

3. The measuring transducer of claim 2, wherein the plurality of emitters are arranged in a row.

4. The measuring transducer of claim 3, wherein the row is oriented tangentially in relation to the dimensional scale to be scanned.

5. The measuring transducer of claim 3, wherein the row is oriented radially in relation to the dimensional scale to be scanned.

6. The measuring transducer of claim 2, wherein the plurality of emitters are arranged in a matrix structure.

7. The measuring transducer of claim 2, wherein a subset of emitters of the plurality of emitters is configured to be activated simultaneously.

8. The measuring transducer of claim 2, wherein a subset of emitters comprising an individual emitter or several emitters is configured to be activated independent of another subset of emitters comprising an individual emitter or several emitters.

9. A method for obtaining position data by scanning a dimensional scale with a measuring transducer of a transmit/receive unit having a plurality of light sources, with at least one light source having a plurality of emitters, comprising activating a subset of emitters of the plurality of emitters simultaneously so as to obtain a specified minimum signal power.

10. The method of claim 9, further comprising:
when an emitter is malfunctioning, performing one of the following operations:
either automatically de-activating the malfunctioning emitter and activating at least one other emitter in its place, or
keeping the malfunctioning emitter activated and activating at least one other emitter in addition.

11. The method of claim 9, further comprising:
automatically activating successive individual emitters or groups of emitters of the plurality of emitters, and
evaluating resulting images produced with the activated individual emitters or groups of emitters for identifying and activating an optimum emitter or a group of optimum emitters.

12. The method of claim 11, further comprising:
automatically comparing maximum signal amplitudes of the resulting images,
automatically identifying an emitter or a group of emitters associated with a maximum signal amplitude as an optimum emitter or as a group of optimum emitters, and
activating the optimum emitter or the group of optimum emitters.

13. The method of claim 11, further comprising:
automatically comparing a deviation of a signal waveform of the resulting images from an associated expected signal waveform,
automatically identifying an emitter or a group of emitters associated with a minimum deviation from the expected signal waveform as an optimum emitter or as a group of optimum emitters, and
activating the optimum emitter or the group of optimum emitters.
